(19) United States
(12) Patent Application Publication
(10) Pub. No.: US 2024/0400798 A1
(43) Pub. Date: Dec. 5, 2024

(54) A method, a product obtained by the method, and dried cellulosic and/or lignocellulosic particles

(71) Applicant: Metsä Fibre Oy, Metsä (FI)

(72) Inventors: Kirsi Hirvonen, Metsä (FI); Raili Koponen, Metsä (FI)

(21) Appl. No.: 18/696,379

(22) PCT Filed: Sep. 28, 2022
(86) PCT No.: PCT/FI2022/050649

§ 371 Date: Mar. 28, 2024

(30) Foreign Application Priority Data
Sep. 28, 2021 (FI) 20216006

(51) Int. Cl. C08L 1/02; B29B 9/14; C08K 5/00; C08L 97/02; D21H 21/16

(52) U.S. Cl. CPC C08L 1/02; B29B 9/14; C08K 5/00; C08L 97/02; D21H 21/16

(57) ABSTRACT

According to an example aspect of the present invention, there is provided a method comprising: providing a wet pulp composition comprising cellulosic and/or lignocellulosic fibres; mixing the wet pulp composition with at least one additive chemical to obtain a mixture of wet pulp and additive chemicals; at a consistency of the mixture of less than 80%, preparing cellulosic and/or lignocellulosic particles from the mixture; drying the particles, wherein fibres in the particles are dispersible to a molten thermoplastic or thermoset matrix to obtain a dispersion of fibres in the molten matrix.

### FIELD

The present invention relates to a method for producing cellulosic and/or lignocellulosic particles preferably suitable for use as a raw material for manufacturing of composite materials.

### BACKGROUND

It is known to utilize cellulosic fibrous materials, such as wood pulp, together with plastic materials, such as thermoplastic or thermoset materials, for manufacturing of composite materials. An important function of the cellulosic fibres is to reinforce the composite structure.

In a typical composite manufacturing process, a masterbatch is first prepared, comprising a concentrated mixture of cellulosic material and plastics. The masterbatch is then diluted with plastic material to make it suitable for feeding to an extrusion process in which a final composite article is formed.

For the purpose of manufacturing a masterbatch, cellulosic fibrous materials are typically milled to obtain a fine powder before mixing the fibres with a plastic material, to enable stabile feeding and dispersion to the plastic material. Milling of the fibres, however, reduces the fibre length and therefore also the reinforcing potential of the fibres in the composite structure.

To omit the need of milling, it is known to pre-mix the cellulosic fibrous material with a plastic material before manufacturing the masterbatch. This approach limits the reinforcing function of the fibres to the plastic material that is used in the pre-mixing step.

It is also known to prepare granulates from a dry cellulosic material. However, such granulates contain highly aggregated cellulosic fibres.

There is a need to develop new fibrous materials for use in manufacturing of wood-plastic composites by processes involving compounding steps.

There is a need for more versatile methods for manufacturing of composites from pulp-based materials and plastic materials so that the composition of the final article, particularly with regard to plastic components, can be varied over a wider range.

There is also a need of increasing sustainability and material efficiency.

Embodiments of the present invention are intended to overcome at least some of the disadvantages in the prior art.

### SUMMARY OF THE INVENTION

The invention is defined by the features of the independent claims. Some specific embodiments are defined in the dependent claims.

According to a first aspect of the present invention, there is provided a method comprising: providing a wet pulp composition comprising cellulosic and/or lignocellulosic fibres; mixing the wet pulp composition with at least one additive chemical to obtain a mixture of wet pulp and additive chemicals; at a consistency of the mixture of less than 80%, preparing cellulosic and/or lignocellulosic particles from the mixture; drying the particles, wherein fibres in the particles are dispersible to a molten thermoplastic or thermoset matrix to obtain a dispersion of fibres in the molten matrix.

Various embodiments of the first aspect may comprise one or more features from the following bulleted list:
Said mixing is carried out at a consistency of 3 to 30%, such as 3 to 10%, such as 3 to 5%, or 5 to 10%.
Said mixing is carried out at a consistency of 10 to 30%.
At least 90 wt-% of the fibres in the particles, of total dry matter, are dispersible to a molten thermoplastic or thermoset matrix to form a stable dispersion, preferably stable for at least 1 hour.
The wet pulp composition comprises or consists of wet wood pulp having a consistency of less than 60%, such as less than 50%, for example in the range 20 to 50%, or 30 to 40%.
The wet pulp composition comprises or consists of a never-dried pulp composition.
The wet pulp composition consists of a never-dried pulp composition.
The mixture comprises a never-dried mixture.
The wet pulp composition comprises or consists of chemical pulp, such as kraft pulp.
The method further comprises, for example before said mixing step, dewatering the pulp composition, preferably to a consistency of at least 3%.
The method further comprises, for example before said mixing step, dewatering the pulp composition, preferably to a consistency of at least 10%, such as 10 to 30%.
In said mixing step, the wet pulp composition has a consistency of at least 10%.
Said at least one additive chemical comprises a hydrophobization agent which makes the fibres or fibre surfaces more hydrophobic, preferably so that the COBB value of the fibres becomes less than 110 g/m², such as less than 100 g/m², such as less than 90 g/m².
Said at least one additive chemical comprises a hydrophobization agent which makes the fibres or fibre surfaces more hydrophobic, preferably so that the COBB value of the fibres becomes less than 50 g/m², such as less than 15 g/m², such as less than 10 g/m².
Said at least one additive chemical is selected from the following group: fatty acids, alkyl ketene dimers (AKD), fatty alcohols, fatty acid esters, biopolymers, cationic polyamines, cationic polyethyleneimines (PEI), cationic or non-ionic polyacrylamides, polydimethyldiallylammonium chloride (pDADMAC), carboxymethyl cellulose (CMC), maleic anhydride (MA), maleic anhydride grafted polypropylene (MAPP), silanes, alkoxysilanes, and derivatives and combinations thereof.
Said at least one additive chemical is selected from the following group: CMC, starch, AKD, a hydrophobization agent, and any combinations thereof.
The method further comprises, before said particle preparation step, mixing the wet pulp composition with a second pulp composition comprising cellulosic and/or lignocellulosic fibres, wherein the composition of the second pulp composition is different from the composition of the wet pulp composition.
The second pulp composition has a consistency of at least 5%, for example 10 to 60%.
The second pulp composition comprises modified wood pulp fibres, which are capable of decreasing inter-fibre interactions, typically non-covalent inter-fibre bonding.
One or both of the wet pulp composition and the second pulp composition comprises fibrillated pulp, such as fibrillated chemical pulp.
The second pulp composition comprises fibrillated chemical pulp.
The second pulp composition comprises microcrystalline cellulose (MCC).
The second pulp composition comprises hydrolysed cellulosic and/or lignocellulosic fibres, preferably hydrolysed cellulosic and/or lignocellulosic softwood fibres.
The method further comprises, before said particle preparation step, dewatering the pulp composition, preferably to a consistency of at least 20%, such as 30 to 60%.
During said particle preparation the mixture has a consistency of 10 to 80%, such as 20 to 60%, for example at least 30%, such as 30 to 40%.
Said particle preparation step produces three-dimensional particles having a dry density in the range 150 to 250 kg/m³.
Said particle preparation step produces three-dimensional particles having a dry density in the range 150 to 700 kg/m³.
Said particle preparation step produces three-dimensional particles of which at least 90 wt-% have all three dimensions in the range 0.1 to 10 cm.
Said drying is carried out by a drum dryer, a belt dryer, cabinet drying, air borne drying, flash drying, or fluidized bed drying, preferably keeping the temperature in the range 40 to 200° C.
The obtained particles comprise less than 5 wt-%, preferably less than 1 wt-%, for example less than 0.5 wt-% plastic material of the total dry matter.
Said cellulosic and/or lignocellulosic fibres do not comprise any recycled or waste or man-made cellulosic and/or lignocellulosic fibres.

According to a second aspect of the present invention, there is provided a product obtained by the method according to the first aspect.

According to a third aspect of the present invention, there are provided dried cellulosic and/or lignocellulosic particles, wherein the particles comprise at least 80 wt-%, such as at least 90 wt-% cellulosic and/or lignocellulosic fibres, of total dry matter; and the particles have a dry density in the range 100 to 250 kg/m³; and wherein fibres in the particles are dispersible to a molten thermoplastic or thermoset matrix to obtain a dispersion of fibres in the molten matrix.

According to a fourth aspect of the present invention, there are provided dried cellulosic and/or lignocellulosic particles, wherein the particles comprise at least 80 wt-%, such as at least 90 wt-% cellulosic and/or lignocellulosic fibres, of total dry matter; and the particles have a dry density in the range 150 to 700 kg/m³; and wherein fibres in the particles are dispersible to a molten thermoplastic or thermoset matrix to obtain a dispersion of fibres in the molten matrix.

Various embodiments of the second aspect or the third aspect or the fourth aspect may comprise one or more features from the following bulleted list:
The product comprises dried particles comprising non-agglomerated cellulosic and/or lignocellulosic fibres.
The product comprises particles that are directly suitable for being fed to a compounding process, to be combined with a thermoplastic or thermoset material for the purpose of preparing a fibre-plastic composite.
The product comprises particles that are dispersible to a molten thermoplastic or thermoset matrix, preferably to form a stable dispersion, for example stable for at least 1 hour.
The dry matter content of the product is at least 85 wt-%, such as at least 95 wt-%, for example at least 99 wt-%.
The product comprises at least 80 wt-%, such as at least 90 wt-%, for example at least 95 wt-% cellulosic and/or lignocellulosic fibres which have preferably been derived from wet chemical pulp, calculated of the total dry matter.
The product comprises at least 0.1 wt-%, such as at least 0.5 wt-%, for example at least 1 wt-%, for example in the range 0.1 to 2 wt-% of at least one additive chemical, or of total additive chemicals, of the total dry matter.
Said at least one additive chemical comprise an agent capable of substantially reducing or preventing inter-fibre interactions.
The particles or fibres have a COBB value less than 110 g/m², such as less than 90 g/m², such as less than 50 g/m².
The particles or fibres have a water contact angle of at least 120°, such as at least 140°.
The product comprises less than 15 wt-%, such as less than 10 wt-%, for example less than 5 wt-%, for example 1 to 10 wt-% water.
The product comprises less than 5 wt-%, such as less than 2 wt-%, for example less than 1 wt-%, for example less than 0.5 wt-% plastic material, such as thermoplastic or thermoset material, of the total dry matter.
The additive chemicals comprise less than 5 wt-%, such as less than 2 wt-%, for example less than 1 wt-%, for example less than 0.5 wt-% plastic material, such as thermoplastic or thermoset material.
Fibres in the particles are dispersible to said thermoplastic or thermoset material when it is in the form of a molten matrix.
The length weighted average fibre length is larger than 0.5 mm, such as less than 5 mm, for example 0.5 to 3 mm, for example 0.7 to 2.5 mm.
The particles have a brightness of at least 60%, such as at least 80%, such as 80 to 90%, as determined according to ISO 2470.
The particles have a dry density of at least 150 kg/m³.
The particles have a dry density in the range 100 to 700 kg/m³, such as 150 to 700 kg/m³.
The particles have a porous structure.
At least 90 wt-% of the particles have a substantially three-dimensional shape, typically a three-dimensional irregular shape.
The particles are three-dimensional particles, preferably of which at least 90 wt-% have all three dimensions in the millimetre to centimetre range.
The particles comprise less than 15 wt-% water.
The particles comprise less than 1 wt-% plastic material, such as thermoplastic or thermoset material.
The particles do not comprise any recycled or waste or man-made cellulosic and/or lignocellulosic fibres.

### Advantages of the Invention

The present invention may simplify the manufacturing process from a wet cellulosic material to a fibre-plastic composite article by providing a new intermediate fibrous product which is directly usable in a compounding process with thermoplastic or thermoset materials.

In some embodiments, agglomeration of the cellulosic fibres may be reduced or even avoided, which may be beneficial in application of the present product in the manufacturing of cellulosic fibre-plastic composite materials.

An advantage of some embodiments of the present invention is that the product may be easy to feed to a compounding process due to its optimal particle size distribution and particle density and also due to the good dispersibility of cellulosic and/or lignocellulosic particles and capability to couple with plastics. Such dispersion and coupling properties may be achieved by means of additive chemicals. The composite manufacturer may thus more freely select the pulp content, such as chemical pulp content, while still achieving good homogeneity of the composite

An advantage of some embodiments of the present invention is that the product may be entirely free from plastic materials, particularly free from thermoplastic and thermoset materials. Therefore, the thermoplastic or thermoset material or materials to be added in a compounding step may be selected more freely in a later stage of a manufacturing process of a composite.

The present invention may thus provide a plastic-free product that is usable as a substantially dry cellulosic starting material in a manufacturing process of a composite comprising a cellulosic material and a plastic material.

The present invention may provide an entirely biodegradable cellulosic product.

Advantages of some embodiments of the present invention include improved properties in a composite product, such as high impact strength.

The present invention may facilitate utilization of cellulosic materials in the manufacturing of composites.

The present invention may reduce or prevent fibre damaging during extrusion and compounding processes.

### BRIEF DESCRIPTION OF THE DRAWINGS

FIG. 1 illustrates as a flow chart the method in accordance with at least some embodiments of the present invention.

### EMBODIMENTS

### Definitions

By “wet pulp” it is referred to a composition comprising pulp dispersed in or mixed with a solvent, such as water or for example ionic liquid. Typically, the wet pulp has a consistency of less than 60%. Preferably, the wet pulp is never-dried and hence originates from a pulping process not including drying steps, for example drying by external heating, such as drying steps increasing the consistency to values above 60%. Such drying typically does not comprise mere dewatering.

By “never-dried pulp” it is referred to a pulp which has not undergone any drying step during the pulping process. Such drying typically does not comprise mere dewatering.

Preferably, the term “wet pulp” refers to “wet and never-dried pulp”.

By “fibrillating” it is referred to a treatment in which external surfaces of cellulosic fibres are fibrillated, which typically leads to increase of surface area, but typically no fibre cutting.

By “cellulosic particles” it is referred to macroscopic cellulosic particles, typically visually discernible, macroscopic cellulosic particles. The cellulosic particles may comprise cellulose and/or lignocellulose, typically cellulose.

By “plastic material” it is typically referred to thermoplastic materials and/or thermoset materials. Thermoplastic materials do not undergo any chemical change in their composition when heated and thus can be moulded repeatedly. Thermoset materials can melt and take shape only once: after they have solidified, they stay solid. If reheated, thermoset materials decompose rather than melt. In the thermosetting process, an irreversible chemical reaction occurs.

By “biodegradability” it is referred to ability to decay naturally and in a way that is not harmful to the environment.

By “dispersion” it is referred to material comprising more than one phase where at least one of the phases consists of finely divided phase domains, such as solid particles or fibres, often in the colloidal size range, dispersed throughout a continuous phase, such as a liquid phase. In the present context, “dispersion of fibres” may refer to a dispersion, which comprises or mainly consists of individually dispersed fibres.

By “stable dispersion” it is referred to a dispersion in which the dispersed phase maintains a consistent particle size over time, such as for one hour, and remains in suspension.

The expression “does not comprise substantially any” typically means “comprises less than 5 wt-%, such as less than 2 wt-%, for example less than 1 wt-%”.

Unless otherwise stated herein or clear from the context, any percentages referred to herein are expressed as percent by weight based on a total weight of the respective composition.

The present invention provides new cellulosic and/or lignocellulosic materials suitable for being used in the manufacturing of composite materials from cellulosic materials and plastic materials. The present invention also provides a method for preparing said cellulosic and/or lignocellulosic materials.

The present product may be prepared as a plastic free, substantially dry product while still retaining sufficient capability to be dispersed into a plastic matrix, such as a thermoplastic or thermoset matrix, and to form bonds with the plastic material.

In some embodiments, the method comprises providing at least one wet pulp composition comprising cellulosic and/or lignocellulosic fibres; mixing the wet pulp composition with at least one additive chemical to obtain a mixture of wet pulp and additive chemicals; at a consistency of less than 80%, preparing cellulosic and/or lignocellulosic particles from the mixture; and drying the particles. Fibres in the particles are dispersible to a molten thermoplastic or thermoset matrix to obtain a dispersion of fibres in the molten matrix.

The method may be combined with various additional process steps, such as fibrillating, refining, adding further pulp compositions, decreasing degree of polymerization, dewatering and/or a further step of adding additive chemicals.

### Wet Pulp

In the present method, the starting material is a wet pulp composition, preferably a composition comprising wet wood pulp. The starting material may be referred to as the first pulp composition.

The cellulosic and/or lignocellulosic fibres may be any cellulosic or lignocellulosic fibres, for example cellulosic or lignocellulosic pulp fibres, such as unbleached or bleached fibres from chemical and/or mechanical pulping, or combinations thereof.

In one embodiment, the pulp may comprise mechanical pulp, semi-chemical pulp, chemical pulp, thermomechanical pulp or chemithermomechanical pulp. Chemical pulp may be produced by any of the following pulping methods: kraft process, sulphite process, organosolv process.

In one embodiment, the pulp may be made from any broad-leaved tree such as a tree from the betulaceae family, for example birch or aspen, from the salicaceae family, from eucalyptus, mixed tropical hardwood or pines or from any combination of the aforementioned. The pulp may be also made from any conifer such as spruce or pine or from any combination thereof. The pulp may be also made from a combination of broad-leaved trees and conifers.

In one embodiment, the pulp may be made from any annual such as straw, common reed, reed canary grass, bamboo, sugarcane, bagasse or any grass plant.

It is advantageous that the cellulosic and/or lignocellulosic fibres are obtained from wood pulp, preferably selected from the following group: chemical pulp, mechanical pulp and mixtures thereof.

The pulp may be a mixture comprising both chemical and mechanical pulps. Preferably, the mixture comprises mostly chemical pulp, such as more than 50 wt-% chemical pulp of the total dry matter.

In one embodiment, the wet pulp composition comprises or consists of chemical pulp, such as bleached or unbleached kraft pulp, which is prepared by a kraft process that involves at least the following steps: cooking (delignification), oxygen delignification, and optionally bleaching.

In one embodiment, the wet pulp composition is never-dried.

The cellulosic and/or lignocellulosic fibres are preferably virgin cellulosic and/or lignocellulosic fibres.

In an embodiment, the wet pulp composition does not comprise any or substantially any cellulosic and/or lignocellulosic fibres originating from waste materials, such as waste or recycled paper or waste or recycled paperboard or broke fibres.

In an embodiment, the wet pulp composition does not comprise any or substantially any textile fibres or recycled textile fibres.

In an embodiment, the wet pulp composition does not comprise any or substantially any regenerated or man-made cellulosic and/or lignocellulosic fibres or filaments.

Preferably, the wet pulp composition does not comprise any or substantially any recycled or waste or man-made cellulosic and/or lignocellulosic fibres. An advantage is improved purity and homogeneity of the particles.

In some embodiments, the consistency of the wet pulp composition, such as wet wood pulp, is less than 60%, such as less than 40%, such as less than 30%, for example in the range 5 to 50% or 20 to 45% or 30 to 40%.

In one embodiment, the wet pulp composition has not undergone any previous drying treatment to less than 30%, such as to less than 10% moisture content, before serving as the starting material of the present method.

### Additive Chemicals

Typically, additive chemicals do not comprise any plastic materials. Thus, additive chemicals are typically non-thermoplastics or non-thermoset plastics.

In one embodiment, the additive chemicals may comprise plastic materials that are different from the plastic materials to which the fibres are dispersible. The advantage is that the present invention may enable incorporation of an amount of plastic material without limiting the choice of plastic material, i.e. the molten plastic matrix used in a subsequent compounding step.

The wet pulp composition is mixed with at least one additive chemical, such as a functional additive chemical, to obtain a mixture of wet pulp and additive chemical.

Preferably, the additive chemicals are added to the wet pulp at a consistency larger than 10%, for example less than 40%, such as 10 to 30%.

In some embodiments, the additive chemicals are added to the wet pulp at a consistency larger than 3%, for example 3 to 10%, such as 3 to 5%.

A relatively low consistency during the adding of additive chemicals is favourable in view of obtaining a homogeneous end product, i.e. the particles.

Mixing is preferably carried out by a mixing device, such as an easy to use mixing device, typically by using low shear forces. Preferably the mixing device is configured to heat and/or cool the mixture if desired. Preferably, additive chemicals, for example in liquid form, are injected into the mixing device, to be mixed with the wet pulp.

Additive chemicals may be added in one or more steps of the present method. Preferably, additive chemicals are added at least before the particle preparation step.

The additive chemicals may comprise for example adsorption agents, dispersion agents, coupling agents, debonding agents and/or surfactants, or combinations thereof.

In preferred embodiments, the additive chemicals are capable of reducing or preventing agglomeration of the cellulosic and/or lignocellulosic fibres during the particle preparation step.

In preferred embodiments, the additive chemicals are capable of improving the dispersibility of the obtained cellulosic and/or lignocellulosic particles, particularly dispersibility to plastic liquid or molten matrices.

In preferred embodiments, the additive chemicals comprise an agent capable of preventing inter-fibre interactions.

Adsorption agents and dispersion agents may be selected from the following group: fatty acids, alkyl ketene dimers (AKD), fatty alcohols, fatty acid esters, biopolymers, cationic polyamines, cationic polyethyleneimines (PEI), cationic or non-ionic polyacrylamides, polydimethyldiallylammonium chloride (pDADMAC), carboxymethyl cellulose (CMC), starch, maleic anhydride (MA), maleic anhydride grafted polypropylene (MAPP), silanes, alkoxysilanes, and derivatives and combinations thereof.

The additive chemicals, such as adsorption agents and dispersion agents, may be selected from any of the following groups:
a) hydrocarbons and/or hydrocarbon compounds and/or hydrocarbon derivatives, which may be unsaturated or saturated, straight-chain or branched or cyclic, and may have functional groups, for example vinyl, alcohol, aldehyde, carboxylic acid as well as ionic and or non-ionic functional groups;
b) polymers and their derivatives, such as polyolefins, polyols, polyelectrolytes, polypeptides, polysaccharides and oligomers and/or monomers thereof, for example polydimethyldiallylammonium chloride (pDADMAC);
c) low molecular weight compounds, such as amino acids, phenolics, fatty acids, fatty acids based chemicals, alcohols, for example, glycerol, propylene glycol, alkyl ketene dimer (AKD);
d) lubricants, waxes, oils, vegetable oils, plant oils;
e) organic and inorganic minerals and mineral derivatives, such as calcium carbonate, talc, kaolin, silanes, siloxane, chitin or chitosan; and
any derivatives and combinations thereof.

Preferably the additive chemicals are non-toxic and not harmful to humans or environment.

Preferably the additive chemicals are compatible with food contact materials and applications.

In one embodiment, the additive chemicals are selected from oils and waxes.

Advantageously, said at least one additive chemical reduces or inhibits agglomeration of the fibres during drying. The reduction or inhibition of fibre agglomeration may be measured by slushing the fibre particles into water and comparing their average fibre floc size to the average fibre floc size in the starting material. The average fibre floc size is preferably substantially similar for the starting pulp material and the cellulosic and/or lignocellulosic particles obtained by the present method.

With the term ‘average fibre floc size’ it is typically referred to the average size of fibre entities or fibre assemblies in the slush. In such fibre entities or fibre assemblies the fibre are associated with each other.

‘A fibre floc’ may be defined as a fibre network in which every fibre is locked in position in the network by contact with at least three other fibres. In some embodiments, the size of such flocs or networks is not increased and the amount of fibres in them is not increased.

Advantageously, said at least one additive chemical is capable of contributing to keeping the fibres apart from each other. The performance or capability of the additive chemical may be determined by measuring conventional pulp sheet properties, such as tensile strength. In one embodiment, the additive chemical preferably does not substantially increase the tensile strength of the cellulosic and/or lignocellulosic particles or at most increases the tensile strength by less than 5%.

Advantageously, said at least one additive chemical is capable of decreasing surface tension of the fibre surfaces as measured by water contact angle.

Advantageously, said at least one additive chemical is capable of reducing or preventing inter-fibre bonding, particularly during the drying step.

Advantageously, said at least one additive chemical exhibits good retention on fibres.

Advantageously, said at least one additive chemical is capable of enhancing flowability, fluidity and/or feedability during compounding.

Advantageously, said at least one additive chemical is a hydrophobization agent capable of making the fibres or fibre surfaces more hydrophobic. Preferably said at least one additive chemical is a hydrophobization agent which makes the fibres or fibre surfaces more hydrophobic, preferably so that the COBB value of the fibres becomes less than 110 g/m², such as less than 90 g/m², such as less than 15 g/m², such as less than 10 g/m².

In some embodiments, additive chemicals may be added in one or more steps during the method. For example, additive chemicals may be added in a fibrillating step, in a DP (degree of polymerization) decreasing step, in a particle preparation step and/or in a drying step.

Typically, additive chemicals are added before the particle preparation step to the wet pulp or to a mixture comprising the wet pulp and optionally further pulps.

Typically, the dosage of an additive chemical, such as an adsorption agent or a dispersion agent, is less than 3 wt-%, such as less than 2 wt-%, such as less than 1 wt-% of the weight of dry pulp.

If several additive chemicals are added, their combined dosage is preferably less than 10 wt-%, such as less than 5 wt-% of the weight of dry pulp.

Additive chemicals may include coupling agents that may enhance the ability of the end product, the dried particles, to couple or bond with a plastic material during manufacturing of a wood-plastic composite from the present product and plastic materials.

Preferably, debonding chemicals or agents are added before and/or during the drying step. The debonding agent is typically a surfactant, such as a cationic or anionic polyelectrolyte. The function of the debonding agent is to keep the cellulose fibres separated from each other, i.e. to prevent the fibres from bonding with each other. The debonding agent may be for example CMC (carboxymethyl cellulose).

Coupling agents may enhance the ability of the end product to couple or bond with a plastic material during manufacturing of a wood-plastic composite from the present product and plastic materials.

Coupling agent is typically an anhydride, such as maleic anhydride (MA), or a polymer, such as maleic acid-grafted polypropylene (MAPP), or an organic-inorganic coupling agent, for example a silane or an alkoxysilane, or any derivative or combination thereof.

In an embodiment, the additive chemicals are selected from the group consisting of CMC, starch, AKD, a hydrophobization agent, and any combinations thereof.

### Adding Further Pulp Compositions

The method may comprise, before said particle preparation step, mixing the wet pulp composition (the first pulp composition) with at least one further or second pulp composition, wherein the composition of the second pulp composition may be different from the composition of the wet pulp composition.

The second pulp composition may comprise a pulp composition, such as a second wet pulp composition, comprising cellulosic and/or lignocellulosic fibres.

The cellulosic and/or lignocellulosic fibres of the second pulp composition may be any cellulosic or lignocellulosic fibres, for example cellulosic or lignocellulosic pulp fibres, such as unbleached or bleached fibres from chemical and/or mechanical pulping, or combinations thereof.

In one embodiment, the pulp of the second pulp composition may comprise mechanical pulp, semi-chemical pulp, chemical pulp, thermomechanical pulp, chemithermomechanical pulp. Chemical pulp may be produced by any of the following pulping methods: kraft process, sulphite process, organosolv process.

In one embodiment, the pulp of the second pulp composition may be made from any broad-leaved tree such as a tree from the betulaceae family, for example birch or aspen, from the salicaceae family, from eucalyptus, mixed tropical hardwood or pines or from any combination of the aforementioned. The pulp may be also made from any conifer such as spruce or pine or from any combination thereof. The pulp may be also made from a combination of broad-leaved trees and conifers.

In one embodiment, the pulp of the second pulp composition may be made from any annual such as straw, common reed, reed canary grass, bamboo, sugarcane, bagasse or any grass plant.

It is advantageous that the cellulosic and/or lignocellulosic fibres of the second pulp composition are obtained from wood pulp, preferably selected from the following group: chemical pulp, mechanical pulp and mixtures thereof.

The pulp of the second pulp composition may be a mixture comprising both chemical and mechanical pulps. Preferably, the mixture comprises mostly chemical pulp, such as more than 50 wt-% chemical pulp of the total dry matter.

In one embodiment, the second pulp composition comprises or consists of chemical pulp, such as bleached kraft pulp, which is prepared by a kraft process that involves at least the following steps: cooking (delignification), oxygen delignification, and optionally bleaching.

Preferably, the further or second pulp composition(s) do not comprise any or substantially any recycled or waste or man-made cellulosic and/or lignocellulosic fibres.

The second pulp composition preferably has a consistency of at least 5%, for example 10 to 60%.

In one example, the second pulp composition may comprise chemical wood pulp having a consistency of at least 10%.

The second pulp composition may comprise modified wood pulp fibres, which are capable of decreasing inter-fibre interactions, such as decreasing non-covalent inter-fibre bonding.

For example, the second pulp composition may have a lower DP, such as less than 500 g/ml.

For example, one or more of the pulp compositions, such as both the wet pulp composition and the second pulp composition, may comprise fibrillated pulp, such as fibrillated chemical pulp.

In one embodiment, one or more of the pulp compositions may comprise refined pulp.

The relative amounts of the wet pulp and the further pulp compositions may be for example from 1:10 to 10:1, calculated from total dry matter.

### Fibrillating Step

Preferably at least one of the pulps, advantageously the second pulp, is fibrillated in order to provide the pulp with desired fibre dimensions and fibre surface properties.

Said fibrillating may be carried out for example by a mechanical treatment, a chemical treatment and/or an enzymatic treatment, preferably by a mechanical treatment.

Preferably said fibrillating is carried out in a refiner with a mechanical treatment. Mechanical treatment may be used to separate the fibres from each other and to increase the surface area of the fibres. Fibrillation may be carried out by refining. The refiner may be equipped with special fillings achieving very low specific edge load.

In the fibrillation the fibre length is not shortened or at least not substantially shortened. Very small amounts of fines may be created upon fibrillating. The fibrillated fibres preferably have a very high fibrillation level.

In one embodiment, as a result of the fibrillating, the surface area of the fibres is increased by at least 15%.

In a preferred embodiment, as a result of the fibrillating the pulp properties are changed. The strength and the elastic modulus of the pulp may be increased. The average fibre length may be maintained. Only small amounts of fibre fines may be created. Simultaneously, fibres may become highly fibrillated.

As a result of the fibrillating, cellulosic fibers in the pulp are turned to highly fibrillated fibres, preferably with a maintained average fibre length. The fibre fibril perimeter may increase because of the highly fibrillated fibre surface.

In one embodiment, wherein during said fibrillating, the length-weighted average fibre length is not decreased or decreases by not more than 20%, such as by not more than 10%, for example by note more than 5%.

In one embodiment, after said fibrillating, the length weighted average fibre length is larger than 0.5 mm, such as less than 5 mm, for example 0.5 to 3 mm, for example 0.7 to 2.5 mm.

In one embodiment, as a result of the fibrillating, the average fibre width increases at least by 5%, for example at least by 10%,

In one example, as a result of the fibrillating, the average fibre width may increase to at least 30 μm.

In one embodiment, as a result of the fibrillating, the fibril perimeter may increase from 3% to 24%.

In one embodiment, the fines content may increase during fibrillating but is not larger than 40%, such as not larger than 20% of the total dry weight of the pulp. Pulp fines are typically defined as the fraction passing a 200 mesh screen with round holes of 76 μm diameter according to the standard SCAN-CM 66:05. Primary fines are generated already during pulping, while further processing of the pulp leads to generation of secondary fines.

In one embodiment, the method comprises fibrillating at least one wet pulp, whereby said at least one wet pulp obtains desired dimensions and surface properties.

In some embodiments, one or more fibrillated pulps, such as fibrillated wet pulps, are mixed with one or more unfibrillated pulps, such as unfibrillated wet pulps, to prepare a mixture of pulps.

In one embodiment, the method comprises fibrillating 2 to 5 wet pulps independently, whereby the initial and final properties of each pulp may be tailored. The starting material pulps may differ from each other for example by composition, origin and/or consistency. Alternatively, the starting material pulps may be identical but fibrillated separately. Said separately fibrillated pulps may be mixed with each other to prepare a mixture of fibrillated pulps.

The fibrillated cellulosic fibers may bond with a plastic polymer better than non-fibrillated cellulosic fibers. Fibrillating only a part of the pulp starting materials may reduce energy costs that are due to fibrillating.

### Refining

In one embodiment, other suitable means for pulp treatment is refining with traditional mechanical refining methods with a conical or disc refiner with traditional fillings. An advantage is that the fibre strength may be increased.

In another embodiment, the wet pulp is not treated by any traditional refining process. An advantage of avoiding refining is that dewatering of the pulp is easy and less drying energy is needed.

In one embodiment, the pulp is refined and fibrillated.

In one embodiment, the pulp is unrefined and fibrillated.

In one embodiment, the pulp is refined and unfibrillated.

In one embodiment, the pulp is unrefined and unfibrillated.

### Adjusting the DP

The method may comprise of step of decreasing the degree of polymerization (DP) of the cellulose. For example, one or more of the pulps used as starting material may undergo a step of decreasing DP before mixing them.

The degree of polymerization (DP) of the cellulose may be decreased by any of the following methods: chemically, mechanically and/or enzymatically. Preferably the DP of the pulp, such as the wet pulp, as measured by viscosity, is less than 700 ml/g, for example in the range 400 to 700 ml/g.

In one embodiment, the step of decreasing the DP of the pulp may be carried out for the second pulp composition, for example before mixing the second pulp with the wet pulp starting material.

In one embodiment, the step of decreasing the DP of the pulp may be carried out in connection with the refining step, either before or after the refining step.

The degree of polymerization of the pulp, as measured by viscosity, may be adjusted to 500 to 800 ml/g before the particle preparation step.

### Dewatering Steps

Dewatering of the pulp composition of the mixture comprising the pulp and the additive chemicals may be advantageous in various steps of the present method in order to adjust the consistency to a suitable level, particularly to a level suitable for mixing additive chemicals and/or to a level suitable for preparing particles.

Said dewatering may be carried out by for example by pressing, by filtering, or by centrifugation.

After the dewatering step, the consistency of the pulp composition is for example 10 to 60%, such as 30 to 60%, preferably 30 to 40%.

In one embodiment, the method comprises dewatering the pulp composition before the mixing step, preferably to a consistency of at least 10%, such as 10 to 30%.

In one embodiment, the method comprises dewatering the pulp composition, before the particle preparation step, preferably to a consistency of at least 20%, such as 30 to 60%.

Preferably the dewatering is carried out before the mixing step. An advantage is that loss of additive chemicals upon dewatering may be avoided.

In some embodiments, the dewatering is carried out after the mixing step but before the particle preparation step.

### Particle Preparation and Drying

The mixture of pulp or pulps and additive chemicals is shaped into particles, for example by using a particle preparation device, such as a pelletizing device or a compactor or other similar device. Preferably, the particle preparation device is fed with wet or never-dried pulp with a consistency of at least 30%, such as 30 to 50%, such as 30 to 40%. In one embodiment, it is possible to feed additive chemicals into the device. The mixture of pulp and additive chemicals is typically then rotated in the device and pressed or shaped into three-dimensional particles comprising loosely bound fibres.

Preferably, the particle preparation device is configured to receive a substantially plastic-free wet pulp composition as an input.

In one embodiments, the particle preparation device comprises an open chamber in which particles are formed or shaped from the mixture of pulp and chemicals. The particle preparation device may comprise a die or a form that is configured to shape particles from the mixture. The mixture of pulp and additive chemicals is preferably pressed through openings in a roller device or die. For example, the roller die may comprise a curved plate comprising openings. The mixture is shaped into long strands, the strands will fall away after having passed the plate, and the strands are then cut to the desired particle length by means of knives. The diameter of the openings in the roller device or die may be between 1 and 10 cm. The resulting diameter in the obtained cellulosic and/or lignocellulosic particles is in the range 0.4 to 4 cm.

Preferably, an extruder or any other similar device involving application of a high pressure in a closed chamber is not used for the particle preparation.

During said particle preparation the mixture preferably has a consistency of at least 10%, such as at least 15%, such as at least 30%, for example in the range 15 to 40%, for example in the range 30 to 50%, such as 30 to 40%.

Preferably, the particle preparation step is adjusted so that the obtained particles have a dry density of at least 150 kg/m³. In one embodiment, said particle preparation step produces three-dimensional particles having a dry density in the range 150 to 250 kg/m³. In one embodiment, said particle preparation step produces three-dimensional particles having a dry density in the range 150 to 700 kg/m³.

Preferably, the obtained cellulosic and/or lignocellulosic particles should have all dimensions in the millimetre to centimetre scale, such as in the range 0.1 to 10 cm. In one embodiment, said particle preparation step produces three-dimensional particles of which at least 90 wt-% have all three dimensions in the range 0.1 to 10 cm, for example 0.1 to 5 cm.

The obtained cellulosic and/or lignocellulosic particles are dried to a suitable moisture content, for example to a moisture content less than 15%, such as less than 5%.

The drying may be carried out for example by a drum dryer, a belt dryer, cabinet drying, air borne drying, flash drying, or fluidized bed drying.

Preferably, no contact drying is applied, such as cylinder drying or web drying.

The fibres are preferably maintained in a non-agglomerated state during the drying. Preferably the drying step does not to increase agglomeration of the fibres.

Advantageously the drying is carried out by a non-contact method, such as by using air or by using a fluidized bed.

Preferably, no pressing or rolls are used during the drying.

After the drying step, the dry matter content of the particles is preferably greater than 90%.

The properties of the end product, the dried cellulosic and/or lignocellulosic particles, are described in the following.

Preferably, the particles are easily degradable to a liquid matrix. In one embodiment, the particles may be easily broken down or disassociated from each other in a liquid matrix. Typically the liquid matrix comprises a molten plastic material.

The cellulosic and/or lignocellulosic particles may be substantially dry or dried.

Typically, the product is in the form of dried cellulosic and/or lignocellulosic particles comprising non-agglomerated cellulosic and/or lignocellulosic fibres.

In one embodiment, the dry matter content of the cellulosic and/or lignocellulosic particles or the product is at least 90 wt-%, such as at least 95 wt-%, for example at least 99 wt-%.

The cellulosic and/or lignocellulosic particles or the product may comprise at least 80 wt-%, such as at least 90 wt-%, for example at least 95 wt-% cellulosic and/or lignocellulosic fibres which have preferably been derived from wet chemical pulp, calculated from the total dry matter.

In some embodiments, the present cellulosic and/or lignocellulosic particles or the product comprises chemical pulp, such as kraft pulp, for example mechanically fibrillated kraft pulp.

Preferably, the present cellulosic and/or lignocellulosic particles or the product do not comprise any or substantially any recycled or waste or man-made cellulosic and/or lignocellulosic fibres.

The cellulosic and/or lignocellulosic particles or the product may comprise at least 0.1 wt-%, such as at least 0.5 wt-%, for example at least 1 wt-%, for example in the range 0.1 to 2 wt-% of at least one additive chemical, of the total dry matter.

In some embodiments, said at least one additive chemical may comprise an agent capable of preventing inter-fibre interactions.

In some embodiments, the cellulosic and/or lignocellulosic particles or the product comprises less than 15 wt-%, such as less than 10 wt-%, for example less than 5 wt-%, for example 1 to 10 wt-% water.

Preferably, the cellulosic and/or lignocellulosic particles or the product comprises less than 5 wt-%, such as less than 2 wt-%, for example less than 1 wt-%, for example less than 0.5 wt-% plastic material, such as thermoplastic or thermoset material, of the total dry matter.

Preferably, the present cellulosic and/or lignocellulosic particles or the product do not comprise any or substantially any synthetic fibres.

In preferred embodiments, the cellulosic and/or lignocellulosic particles or the product is free from plastic materials. Particularly, the cellulosic and/or lignocellulosic particles or the product may be free from thermoplastic materials, such as polyolefins, such as polyethylene or polypropylene, polyester, polyethylene terephthalate (PET), polyvinyl chloride, polycarbonate and polystyrene.

In one embodiment, the cellulosic and/or lignocellulosic particles or the product comprises less than 10 wt-%, such as less than 5 wt-%, for example less than 2 wt-% fibres in the form of fines.

In an embodiment, the cellulosic and/or lignocellulosic particles or the product may have a brightness of at least 60%, such as at least 70%.

For example, the cellulosic and/or lignocellulosic particles or the product may have a brightness of at least 80%, such as 80 to 90%. In one example, the particles or the product may have a brightness less than 95%.

The brightness is typically determined according to ISO 2470.

In one embodiment, the cellulosic and/or lignocellulosic particles or the product have a dry density of at least 100 kg/m³, such as at least 150 kg/m³, for example at least 180 kg/m³, for example in the range 100 to 250 kg/m³.

In one embodiment, the cellulosic and/or lignocellulosic particles or the product have a dry density in the range 100 to 700 kg/m³, such as in the range 250 to 700 kg/m³.

A relatively high density is favourable in view of making the particles more flowable and more easily feedable during further processing for example into a compounding process.

Typically, the cellulosic and/or lignocellulosic particles or the product have a porous structure.

In some embodiments, at least 90 wt-%, such as at least 95 wt-% of the particles have a substantially three-dimensional shape. Typically, all three dimensions of the particles are then of the same order of magnitude, such as in the range of millimetres and/or in the range of centimetres.

In one embodiment, for at least 90 wt-% of the particles, all three dimensions of the particles are at least 0.1 cm, such as in the range 0.1 to 2 cm, such as 0.5 to 1.5 cm.

In one embodiment, for at least 90 wt-% of the particles, the particles may have one dimension, for example length, in the range 0.7 to 1.5 cm, and another dimension, for example width, in the range 0.4 to 1.2 cm.

The particles may comprise fibres the hydrophobicity of which has been increased by means of mixing additive chemicals, such as hydrophobization agents to the pulp composition comprising said fibres.

The particles may have a water contact angle of at least 90°, such as at least 100°, such as at least 130°.

The particles or the product may have a COBB value less than 100 g/m², or 80 to 120 g/m², even less than 40 g/m². When the COBB value is less than 40 g/m², the water-absorbing capability of the particles is significantly reduced or even inhibited.

In some embodiments, the particles or the product may have a COBB value less than 50 g/m², or 10 to 30 g/m², or less than 15 g/m².

The present product may be substantially biodegradable.

The present product is preferably directly feedable to a compounding process, preferably to be combined with a thermoplastic or thermoset material for the purpose of preparing a fibre-plastic composite. “Compounding” refers to a process in which a plastic polymer is melted and mixed with other compounds or additives, such as filler, fibres and/or reinforcing materials.

The present product is preferably directly feedable, as free-flowing, to a compounding process in which it is mixed with a plastic material and extruded to prepare a composite product comprising wood-based cellulosic fibres.

The particles typically comprise dried particles comprising non-agglomerated cellulosic and/or lignocellulosic fibres.

In one embodiment, the particles are dispersible to a molten thermoplastic or thermoset matrix to obtain a dispersion of fibres in the molten matrix, preferably to form a stable dispersion, for example stable for at least 1 hour.

The present product may impart improved strength properties to a composite product.

Turning now to the drawings:

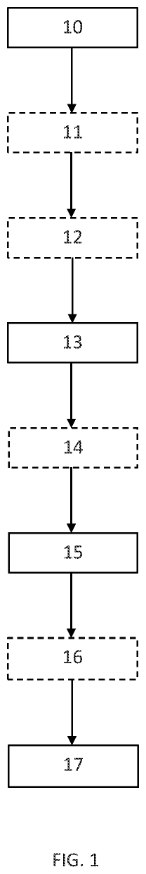

FIG. 1 illustrates as a flow chart the method in accordance with an embodiment of the present invention. The method includes the steps of providing a wet pulp in step 10, adding additive chemicals to the wet pulp in step 13, preparing cellulosic particles from the mixture of wet pulp and additive chemicals in step 15, and drying the cellulosic particles in step 17.

One or more optional steps, shown as dashed boxes, may be incorporated in the method:

In one embodiment, the wet pulp may be refined in step 11 before adding additive chemicals in step 13.

In one embodiment, a further pulp, such as a second pulp, may be added in step 12 and mixed with the wet pulp before adding additive chemicals in step 13.

In some embodiments, the mixture of pulp or pulps and additive chemicals may be dewatered in step 14 before the particle preparation step 15.

A second step of adding additive chemicals, step 16, may be applied after the particle preparation step 16.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present invention is industrially applicable at least in the manufacturing of cellulosic materials suitable for compounding with plastic materials.

### REFERENCE SIGNS LIST

10 providing a wet pulp
11 refining
12 adding a second pulp
13 adding additive chemicals
14 dewatering
15 preparing particles
16 adding additive chemicals
17 drying

1. A method comprising:
providing a wet pulp composition comprising cellulosic and/or lignocellulosic fibres;
mixing the wet pulp composition with at least one additive chemical to obtain a mixture of wet pulp and the at least one additive chemical;
at a consistency of the mixture of less than 80%, preparing cellulosic and/or lignocellulosic particles from the mixture; and
drying the particles.

2. (canceled)

3. The method according to claim 1, wherein the wet pulp composition comprises or consists of wet wood pulp having a consistency of less than 60%.

4. The method according to claim 1, wherein the wet pulp composition is a never-dried pulp composition.

5. The method according to claim 1, wherein the wet pulp composition comprises or consists of chemical pulp.

6. (canceled)

7. The method according to claim 1, wherein said at least one additive chemical comprises a hydrophobization agent which makes the fibres or fibre surfaces more hydrophobic, preferably-so that the COBB value of the fibres becomes less than 110 g/m².

8. The method according to claim 1, wherein said at least one additive chemical is selected from the group consisting of: fatty acids, alkyl ketene dimers (AKD), fatty alcohols, fatty acid esters, biopolymers, cationic polyamines, cationic polyethyleneimines (PEI), cationic or non-ionic polyacrylamides, polydimethyldiallylammonium chloride (pDADMAC), carboxymethyl cellulose (CMC), maleic anhydride (MA), maleic anhydride grafted polypropylene (MAPP), silanes, alkoxysilanes, and derivatives and combinations thereof.

9. The method according to claim 1, further comprising, before said particle preparation step, mixing the wet pulp composition with a second pulp composition comprising cellulosic and/or lignocellulosic fibres, wherein the composition of the second pulp composition is different from the composition of the wet pulp composition.

10. The method according to claim 9, wherein the second pulp composition has a consistency of at least 5%.

11. The method according to claim 9, wherein the second pulp composition comprises modified wood pulp fibres, which are capable of decreasing inter-fibre interactions, typically non-covalent inter-fibre bonding.

12. The method according to claim 1, wherein one or both of the wet pulp composition and the second pulp composition comprises fibrillated pulp.

13. The method according to claim 1, further comprising, before said particle preparation step, dewatering the pulp composition, to a consistency of at least 20%.

14. The method according to claim 1, wherein during said particle preparation the mixture has a consistency of 10 to 80%.

15-17. (canceled)

18. A product obtained by the method according to claim 1.

19. The product according to claim 18, wherein the product comprises_dried particles, the dried particles comprising non-agglomerated cellulosic and/or lignocellulosic fibres.

20-21. (canceled)

22. The product according to claim 18, wherein the dry matter content of the product is at least 85 wt-%.

23. The product according to claim 18, wherein the product comprises at least 80 wt-% cellulosic and/or lignocellulosic fibres, calculated of total dry matter.

24-24. (canceled)

26. The product according to claim 18, wherein the particles or fibres have a COBB value less than 110 g/m².

27. The product according to claim 18, wherein the particles or fibres have a water contact angle of at least 120°.

28. The product according to claim 18, comprising less than 5 wt-% plastic material of the total dry matter.

29. (canceled)

30. The product according to claim 18, wherein the length weighted average fibre length is larger than 0.5 mm.

31. (canceled)

32. The product according to claim 18, wherein the particles have a dry density of at least 150 kg/m³.

33. (canceled)

34. Dried cellulosic and/or lignocellulosic particles, wherein
the particles comprise at least 80 wt-% cellulosic and/or lignocellulosic fibres, of total dry matter; and
the particles have a dry density in the range 100 to 250 kg/m³.

35. The particles according to claim 34, wherein the particles are three-dimensional particles, of which at least 90 wt-% have all three dimensions in the millimetre to centimetre range.

36. The particles according to claim 34, wherein:
the particles comprise less than 15 wt-% water; and
the particles comprise less than 1 wt-% plastic material.

37. (canceled)

38. The method according to claim 1, wherein fibres in the particles are dispersible to a molten thermoplastic or thermoset matrix to obtain a dispersion of fibres in the molten matrix.

39. The method according to claim 1, wherein, during the mixing step, the wet pulp composition has a consistency of 10 to 30%.
